(19) United States
(12) Patent Application Publication
(10) Pub. No.: US 2015/0310472 A1
(43) Pub. Date: Oct. 29, 2015

(54) MANAGEMENT OF ON-DEMAND CONTENT

(71) Applicant: Microsoft Corporation, Redmond, WA (US)

(72) Inventors: Paul Seth Davidson, Bellevue, WA (US); Christopher L. Wimmer, Issaquah, WA (US); Alexander John Garden, Clyde Hill, WA (US); Naud Frijlink, Seattle, WA (US); Michael Scott Seamons, Redmond, WA (US); Brian Shobe, Woodinville, WA (US); John Paddleford, Redmond, WA (US); Madlena Blagaila Measelle, Seattle, WA (US)

(73) Assignee: Microsoft Corporation, Redmond, WA (US)

(21) Appl. No.: 14/260,065

(22) Filed: Apr. 23, 2014

(51) Int. Cl. G06Q 30/02; G06Q 50/18; G06Q 50/00

(52) U.S. Cl. CPC G06Q 30/0222; G06Q 50/01; G06Q 50/184

(57) ABSTRACT

Various embodiments relating to managing content sharing and consumption are disclosed. In one embodiment, a consumer may be issued a lifetime license for a content item. In response to issuing the lifetime license to the consumer one or more share credits may be issued to the consumer. A request to consume a requested content item on a temporary basis may be received from the consumer. A temporary digital authorization usable by the consumer to consume the requested content item on a temporary basis may be issued to the consumer in exchange for a share credit.

### BACKGROUND

Digital content may be acquired and consumed by a consumer on-demand in a variety of ways. For example, digital content may be acquired and consumed on-demand on a permanent basis or a temporary basis. In one example, a consumer may acquire a content item and have permanent ownership of that content item by acquiring a lifetime license for that content item, such as by paying a purchase fee for the lifetime license. In this example, the lifetime license may allow the consumer to consume the content item on-demand in perpetuity whenever the consumer desires without having to pay additional fees.

In another example, a consumer may acquire a content item and have limited access to that content item by acquiring a temporary license for that content item, such as by paying a rental fee that is less than the purchase fee. In this example, the temporary license may allow the consumer to consume the content item on-demand on a temporary basis (e.g., a single consumption, a limited number of consumptions, an unlimited number of consumptions over a limited duration, etc.). Upon expiration of the temporary license, the consumer would have to acquire another temporary license in order to consume the content item again.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments relating to management of on-demand content consumption are disclosed. In one embodiment, a consumer is issued a lifetime license for a content item. In response to issuing the lifetime license to the consumer, one or more share credits are issued to the consumer. A temporary digital authorization usable by the consumer to consume a requested content item on a temporary basis is then issued to the consumer in exchange for a share credit.

### BRIEF DESCRIPTION OF THE DRAWINGS

FIG. 1 shows a computing system according to an embodiment of the present disclosure.

FIG. 2 shows a graphical user interface (GUI) displaying a consumer home page according to an embodiment of the present disclosure.

FIG. 3 shows a GUI displaying a movies section of a content catalogue according to an embodiment of the present disclosure.

FIG. 4 shows a GUI displaying an example scenario of a consumer being debited a share credit in exchange for consuming a movie on a temporary basis.

FIG. 5 shows a GUI displaying an example scenario of a consumer being credited with a plurality of share credits in response to the consumer purchasing a lifetime license to permanently own a movie.

FIG. 6 shows a GUI displaying an example scenario in which a consumer has an inner circle of friends that can barrow movies permanently owned by the consumer without paying an associated cost.

FIG. 7 shows a GUI displaying an example scenario in which a consumer designates permanently owned movies as shared movies or private movies.

FIG. 8 shows a method for managing consumption of content according to an embodiment of the present disclosure.

FIG. 9 shows a method for managing privacy of content permanently owned by a consumer according to an embodiment of the present disclosure.

FIG. 10 shows a method for managing content sharing for an inner circle of friends of a consumer according to an embodiment of the present disclosure.

FIG. 11 shows a method for managing distribution of content licenses of a plurality of content providers according to an embodiment of the present disclosure.

FIG. 12 shows a computing system according to an embodiment of the present disclosure.

### DETAILED DESCRIPTION

The present disclosure relates to management of on-demand digital content consumption. More particularly, the present disclosure relates to a mechanism for increasing consumer acquisition of lifetime licenses for digital content items while providing additional consumer benefits that may be more appealing than just consuming content on a temporary basis. In particular, when a consumer purchases a lifetime license for a digital content item, the consumer may additionally receive one or more share credits that act as a vehicle for consuming other digital content on a temporary basis. In particular, a consumer may exchange a share credit for a temporary digital authorization usable to consume a content item on a temporary basis.

In one example, a consumer may purchase a lifetime license for a content item, for example by paying a purchase fee. In response to purchasing the lifetime license, the consumer may be issued a limited number of share credits that the consumer can use to consume content items on a temporary basis. In some cases, a small share fee may be associated with use of a share credit. When the consumer has used all issued share credits, the consumer may purchase a lifetime license for another content item and be issued another limited number of share credits to continue consuming content on a temporary basis while growing his/her collection of permanently owned content items.

The above described mechanic may create a flywheel that drives demand for lifetime licenses of digital content items. The mechanic may be desirable from the perspective of consumers, because a consumer can grow his/her collection of permanently owned content items while also consuming content on a temporary basis for a similar cost of consuming a same amount of content only on a temporary basis. The mechanic may be desirable from a perspective of content providers, because the mechanic may increase sales of lifetime licenses of content items that have higher royalty revenue relative to revenue from content consumption on a temporary basis.

In some embodiments, the above described mechanic may leverage a consumer's social graph to share permanently owned content items between family, friends, and other members of the consumer's social graph. In this case, a consumer's social graph defines a consumer's relationships with other members of one or more social networks or other online communities. In one example, share credits only can be used to consume content items that are permanently owned by social network friends of the consumer. Such a mechanic may be similar to borrowing from a friend a physical copy of a content item, such as a DVD.

Furthermore, in the above described mechanic, a customer may be presented with a collection of content items permanently owned by friends of the customer. The customer may be granted the right to borrow any content item in the collection in exchange for a share credit without having to wait for an offer from the owner of a content item to borrow that content item. In other words, sharing may be initiated by a borrower instead of a lender. Note that this mechanic differs from a mechanic where a customer is granted the right to lend permanently owned content items to friends. In particular, in the lending scenario, friends are not incentivized to browse a customer's collection of permanently owned content items, because the friends do not have the ability to request to borrow a content item. Rather, the friends are merely capable of receiving an offer from a customer to be lent a content item that is permanently owned by that customer. Although, it will be understood that in some implementations, a consumer may lend a content item permanently owned by the consumer to a friend in exchange for a share credit.

By combining the share credits concept with borrowing content items of social network friends, permanent ownership of content may drive consumer value through sharing. For example, consumers may want to be linked with friends who have great collections of content, and conversely this encourages a consumer to continuously bring new content to his/her friends. In other words, content owned by a consumer may be of high interest and value to his/her social network friends, and content owned by social network friends of the consumer may be of high interest and value to the consumer.

Furthermore, the present disclosure may relate to managing and distributing content licenses from a plurality of content providers in order to implement the above described mechanic in a manner that appears seamless to the consumer.

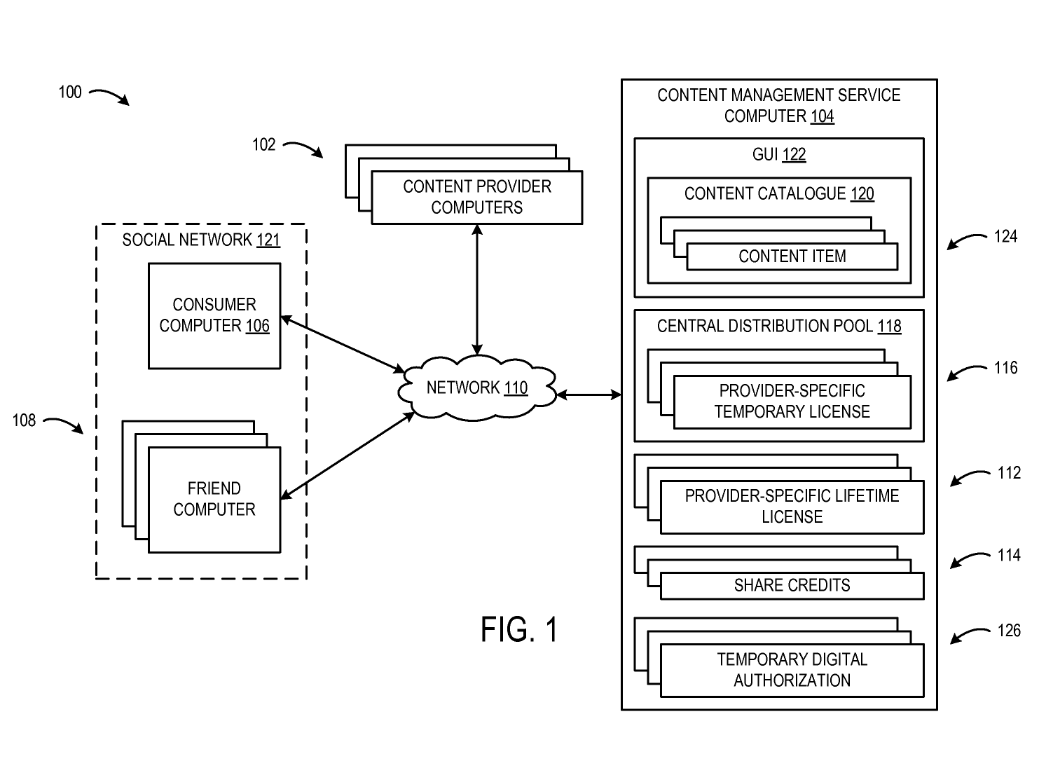

FIG. 1 shows a computing system 100 in which the above described mechanic may be implemented. The computing system 100 may include a plurality of content provider computers (referred to herein as content providers) 102, a content management service computer (referred to herein as a content management service) 104, a consumer computer (referred to herein as a consumer) 106, and a plurality of friend computers (referred to herein as friends) 108 connected via a network 110, such as the Internet. These computers may take the form of one or more personal computers, server computers, tablet computers, home-entertainment computers, network computing devices, gaming devices, mobile computing devices, mobile communication devices (e.g., smart phone), and/or other computing devices.

The plurality of content providers 102 may be configured to provide various different digital content items to the computing system for consumption by consumers. A content provider may take any suitable form without departing from the scope of the present disclosure. Non-limiting examples of content providers include movie and/or television studios, music labels, software (e.g., application, game, etc.) developers, and other suitable sources of digital content. The digital content items may be acquired by consumers via various different types of licenses, and the plurality of content providers may receive various forms of royalties depending on the type of licenses issued to the consumers for the content items.

The content management service 104 may be configured to manage licensing and distribution of digital content items provided by the plurality of content providers 102. The content management service 104 may be configured to receive from each of the plurality of different content providers 102 a plurality of provider-specific lifetime licenses 112. A provider-specific lifetime license may allow a consumer to permanently own a particular content item provided by that content provider. Further, the content management service may be configured to issue the provider-specific lifetime licenses to consumers. For example, a consumer may pay a purchase fee in exchange for a lifetime license that grants permanent ownership of a content item to the consumer. In this case, permanent ownership means that the consumer may consume that content item repeatedly on-demand without paying any additional fees or other costs. The content management service may be configured to provide a purchase royalty to an appropriate content provider of the content item for which the lifetime license is issued.

In response to issuing a lifetime license to a consumer, the content management service 104 may be configured to issue one or more share credits 114 to the consumer. A share credit may be exchanged for a temporary license that allows the consumer to consume a content item on a temporary basis.

Furthermore, the content management service 104 may be configured to receive from each of the plurality of different content providers 102 a plurality of provider-specific temporary licenses 116. A provider-specific temporary license may allow a consumer to consume any content item provided by that content provider. Further, the content management service may be configured to issue the provider-specific temporary licenses to consumers. For example, a consumer may exchange a share credit and pay a share fee for a temporary license that allows consumption of a content item on a temporary basis. The content management service may be configured to provide a share royalty to an appropriate content provider of the content item for which the temporary license is issued.

It will be understood that the above described licenses are merely example, and any suitable licensing scheme may be implemented without departing from this disclosure. Furthermore, when a license for a content item is issued to a consumer, that license may provide to the consumer any suitable form of rights or access to consume the content item. In one example, the license may be applied to the consumer as a person or identity, such that the consumer may consume the content item on any suitable device as long as the consumer's identity is recognized In another example, the license may be applied to one or more particular devices associated with the consumer. In another example, the license may be applied to an account of the consumer. In another example, the license may be applied to a particular domain associated with the consumer. It is to be understood that all of the above, as well as all other suitable mechanisms, are contemplated when this disclosure refers to providing a consumer with a license.

Continuing with FIG. 1, the content management service may be configured to aggregate the plurality of provider-specific temporary licenses 116 from the plurality of different content providers in a central distribution pool 118. By pooling all provider-specific temporary licenses together, the content management service may issue share credits to consumers that can be exchanged for any content item from any content provider without the consumers being limited to content from the particular content provider associated with his/her share credits. Correspondingly, the content management service may track which content items are being consumed in order to remove appropriate provider-specific temporary licenses from the central distribution pool and provide share royalties to appropriate content providers.

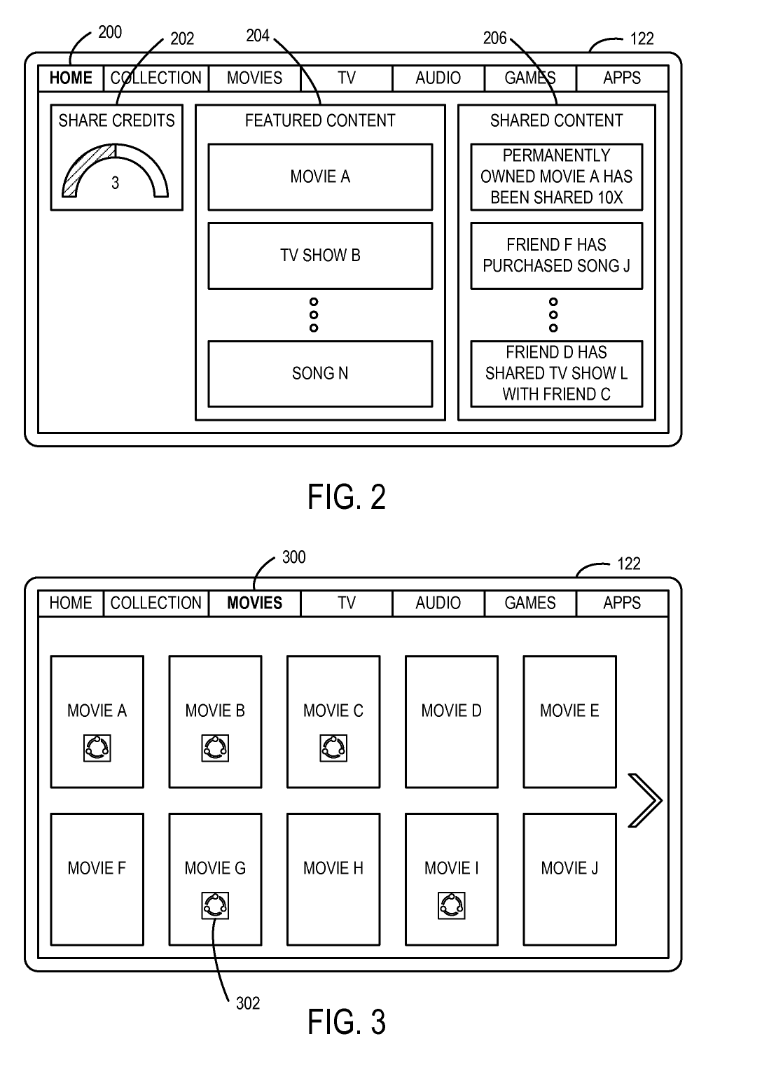

The content management service 104 may be configured to provide information to consumers of the computing system (e.g., consumer 106 and the plurality of friends 108) to display a content catalogue 120 via a graphical user interface (GUI) 122. Various examples of the GUI 122 will be discussed in further detail below with reference to FIGS. 2-7. The content catalogue 120 may include digital content items provided by the plurality of content providers 102. Non-limiting examples of a digital content item include a movie, television show, audio track (e.g., song, podcast, etc.), book, magazine, article, software application, game, and other suitable digital media content that can be consumed on-demand. Although the content catalogue is shown in the content management service, it will be appreciated that the content catalogue may be stored in any suitable location (e.g., a consumer computer, a content provider computer, a content distribution service computer, a computer associated with a social network 121, etc.).

The content catalogue 120 may be organized in any suitable manner. For example, each type of content item may be displayed in a different section. Further, each section may be broken down into specific categories. In another example, the content catalogue may include collections of various consumers. In particular, a consumer may view his/her permanently owned collection in the content catalogue.

Furthermore, a consumer may make some or all of his/her collection of content items viewable/available in the catalogue to social network friends. In particular, a consumer may select one or more content items in his/her collection as shared content items and one or more content items in his/her collection as private content items. The content management service may be configured to allow the shared content items to be available to be consumed on a temporary basis by social network friends of the consumer in exchange for a share credit. In other words, a friend of the consumer can exchange a share credit to consume a content item permanently owned by the consumer. In this case, the friend of the consumer may select the content item to be borrowed. The content management service may be configured to hide ownership of the private content items to the social network friends of the consumer. In one example, the private content items may be hidden from a view of the consumer's collection. In another example, the private content items may be shown without a share icon in a mixed view that includes some content items permanently owned by the consumer along with some content items not owned by the consumer.

In another example, the content management service may be configured to allow the shared content items permanently owned by the consumer to be lent to friends of the consumer in exchange for a share credit. In particular, the consumer can exchange a share credit to have a temporary digital authorization issued to a social network friend. The temporary digital authorization may allow the friend to consume a content item permanently owned via a lifetime license by the consumer. In this case, the consumer may select the content item to be lent to the friend.

Furthermore, a consumer may view a collection of content items permanently owned by social network friends of the consumer. In some embodiments, content items permanently owned by social network friends of the consumer may be shown with share icons. A share icon may provide an easily recognizable visual representation of content items that can be borrowed or temporarily consumed in exchange for a share credit. The share icon may be particularly useful in scenarios where content items permanently owned by social network friends are mixed with content items that are not permanently owned by social network friends.

In some embodiments, in order to promote sharing between social network friends and growing each consumer's collection of permanently owned content items, each consumer may be issued content upon signing up for participation with the content management service. In one example, each consumer may be issued a lifetime license for a content item and accordingly a number of share credits associated with the issuance of the lifetime license. Accordingly, an initial barrier to entry for consumers to collect and share content may be lowered.

Consumers of the computing system may send requests to the content management service to consume content items selected from the content catalogue 120. The requests may be for either permanent or temporary consumption of the requested content item. If a request is for permanent consumption, the content management service may be configured to issue to the consumer a lifetime license for the content item in exchange for a purchase fee. If a request is for temporary consumption, the content management service may be configured to issue to the consumer a temporary license for the content item in exchange for a share credit. In some embodiments, the temporary license may be exchanged for a share credit and a share fee. In some embodiments, the temporary license may be exchanged for a rental fee that is greater than the share fee without exchanging a share credit.

In some embodiments, a pricing scheme may be implemented such that a total cost for a consumer to purchase a lifetime license and use the corresponding share credits is approximately the same as the cost to rent the same content items. In other words, the consumer can buy one item and rent others for approximately the same, or even a lower, cost as renting those items. In one particular example, three share credits are issued for each purchase and the total cost of the purchase fee and three share fees is approximately the same as the total cost of four rental fees.

In some embodiments, a consumer may make a selection of inner circle friends that are a limited subset of all social network friends of the consumer. In one example, a consumer may select five friends or family from his/her social network friends to be inner circle friends. The content management service may be configured to allow the plurality of content items permanently owned by the consumer to be available to be consumed on a temporary basis by the inner circle friends without an associated cost, such as a share credit, share fee, or rental fee. In other words, the inner circle friend can borrow the consumer's content items free of charge. In some embodiments, additional consumption restrictions may be applied to content items consumed by inner circle friends. For example, a content item may be restricted to being viewed by only one inner circle friend at a time, a lesser fee may be applied, etc. It will be understood that any suitable number of social network friends may be selected as inner circle friends depending on the licensing scheme employed.

In some embodiments, share credits may be earned in ways other than purchasing a lifetime license for a content item. For example, share credits may be earned based on a size of a consumer's permanent collection of content items. In another example, share credits may be earned based on a number of friends that have borrowed a content item from the consumer. In another embodiment, share credits may be earned based on a number of times a content item has been borrowed by a social network friend. In another example, share credits may be earned based on associated experiences, such as earning shared credits responsive to being awarded an achievement in a video game or other social networking experience.

Furthermore, in some embodiments, share credits may be exchanged for things other than borrowing content items. For example, a large number of share credits could be saved up to purchase a content item on a permanent basis. In another example, share credits could be used for related experiences. In one example, instead of using a share credit to borrow movies from a friend, a plurality of share credits could be used to purchase a ticket to a movie showing at a movie theater. It is to be understood that share credits can be exchanged for virtually any goods, services, and/or experiences without departing from the scope of this disclosure.

When the content management service issues to a consumer a license for a content item, the consumer is granted rights or is otherwise allowed to consume the content item. Further, in order to actually acquire the content item for consumption, the content management service may be configured to issue to the consumer a digital authorization. A digital authorization may enable a content item to be electronically accessible to a consumer. A digital authorization may take any suitable form. In one example, a digital authorization may be a cryptographic key that can be used to decrypt an encrypted media content item. It will be understood that the digital authorization may abide by any suitable digital rights management scheme without departing from the scope of the present disclosure. In some cases, a digital authorization may be a permanent digital authorization that may be used once or repeatedly to access a permanently owned content item. In some embodiments, a permanent digital authorization may be repeatedly updated to a different digital authorization to inhibit theft. Further, as long as the consumer maintains the lifetime license for the content item, the updated digital authorization may be issued to the consumer to provide continued access to the content item. In some cases, a digital authorization may be a temporary digital authorization that may be used for a limited number of accesses of a content item or used to access a content item for a limited duration.

Furthermore, it will be understood that a consumer may acquire a content item for consumption in any suitable manner. For example, a consumer may download and store a content item on a storage machine located on the consumer computer. If the content item is being consumed on a permanent basis, then the content item may remain on the storage machine. If the content item is being consumed on a temporary basis, then the content item may be deleted from the storage machine after a temporary license for the content item has expired.

In another example, a consumer may stream a content item from a remote location. In some embodiments, content items may be streamed from the content management service. In some embodiments, content items may be streamed from a content provider. In some embodiments, content items may be streamed from another source such as a content distribution server, a content distribution network, a peer-to-peer-network, or a combination thereof.

Furthermore, it will be understood that a consumer's collection of permanently owned content items may be stored at any suitable location. In some embodiments, some or all of the collection may be stored locally in a storage machine of the consumer computer. In some embodiments, some or all of the collection may be stored remotely in a storage machine of a remote computer, such as the management service or another distribution service. In some cases, remotely stored permanently owned content items may be consumed on-demand via streaming In some embodiments, some or all of the collection may be stored locally and remotely. For example, a backup copy may be stored at a remote location such as in a virtual locker.

FIGS. 2-7 show different views of an example GUI 122 that may use information from the content management service 104. The GUI 122 may display content catalogue 120 organized into different pages of content items. For simplicity sake, examples discussed herein are directed to movie content items, although it will be understood that such examples are broadly applicable to any suitable type of content item.

FIG. 2 shows GUI 122 displaying a consumer home page 200 according to an embodiment of the present disclosure. The home page 200 may include a share meter 202, a featured content pane 204, and a shared content feed 206. The share meter may indicate a total number of share credits available for use by the consumer. The share meter may indicate when a share credit is credited to the consumer, and the share meter may indicate when a share credit is debited from the consumer. The feature content pane 204 may display different content items that may be of interest to the consumer, such as newly released content items, popular content items, and the like. The shared content feed 206 may include information relating to events involving a content item being shared by the consumer with social network friends of the consumer, a content item being shared between social network friends of the consumer, and a content item becoming available to be borrowed by the consumer from a social network friend of the consumer. The shared content feed may aid a user in discovering new content shared among social network friends of the consumer that may influence the consumer to consume such content.

FIG. 3 shows the GUI 122 displaying a movie section 300 of content catalogue 120 according to an embodiment of the present disclosure. The movie section 300 shows a variety of movies available to the consumer for consumption either on a permanent basis or a temporary basis. Each movie that is made available and permanently owned via a lifetime license by any social network friend of the consumer is indicated by a share icon 302. The movies displayed with share icons can be easily identified by the consumer as being eligible to be consumed on a temporary basis in exchange for a share credit. Movies that are shown without a share icon are not eligible to be consumed using a share credit. Instead, these movies may be consumed on a permanent basis by paying a purchase fee to purchase a lifetime license. Further, these movies may be consumed on a temporary basis by paying a rental fee to purchase a temporary license.

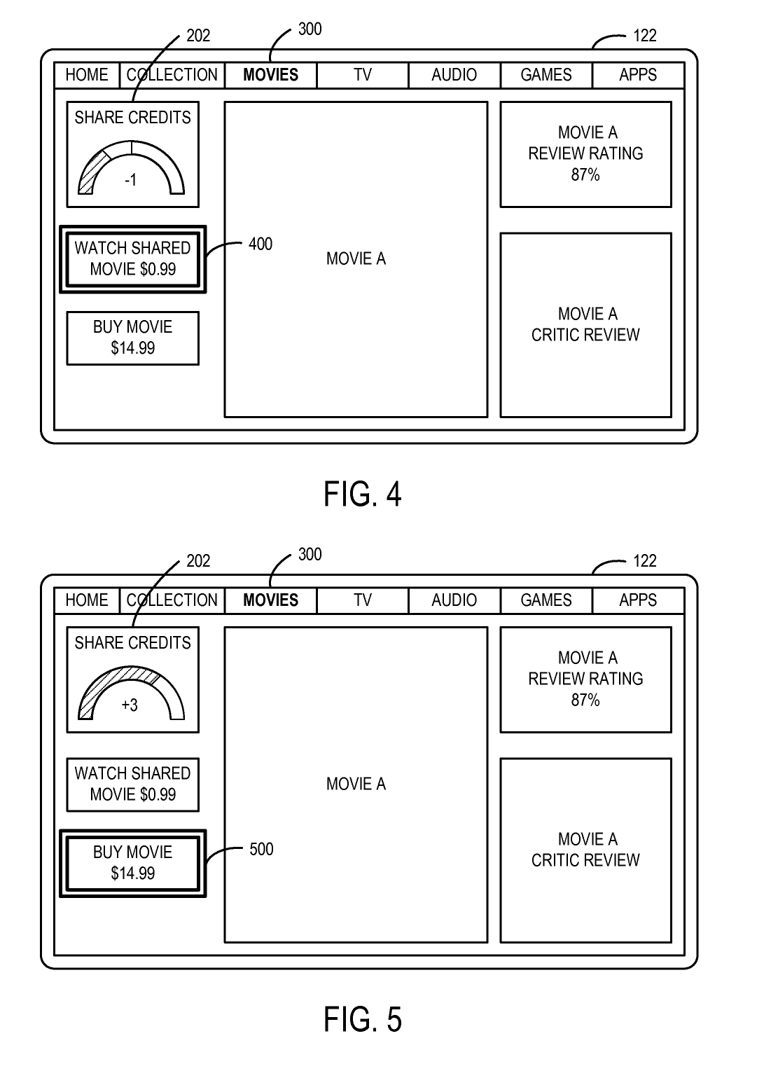

FIG. 4 shows the GUI 122 displaying an example scenario of a consumer being debited a share credit in exchange for consuming a movie on a temporary basis. In particular, the consumer selects movie A in the movie section 300. Once selected, a larger scale version of movie A (e.g., a movie poster) is displayed with a rating and a movie critic review. The consumer requests to consume movie A on a temporary basis by selecting the “WATCH SHARED MOVIE $0.99” selector 400. In response to selection of the selector 400, the consumer is debited a share credit, which is indicated by the share meter 202. Further, in this example, the consumer pays a share fee of $0.99 to consume move A on a temporary basis.

FIG. 5 shows the GUI 122 displaying an example scenario of a consumer being credited with a plurality of share credits in response to the consumer purchasing a lifetime license to permanently own a movie. In particular, the consumer selects movie A in the movie section 300. Once selected, a larger scale version of movie A (e.g., a movie poster) is displayed with a rating and a movie critic review. The consumer requests to consume movie A on a permanent basis by selecting the “BUY MOVIE $14.99” selector 500. In response to selection of the selector 500, the consumer is credited three share credits, which is indicated by the share meter 202. Further, in this example, the consumer pays a purchase fee of $14.99 to consume move A on a permanent basis.

It will be understood that any suitable number of share credits may be issued to the consumer in response to the consumer purchasing a content item. In some embodiments, a number of share credits issued responsive to issuing a lifetime license for a content item may vary based on a type of the content item. In one example, a greater number of share credits may be issued responsive to a purchase of a more expensive content item and a lesser number of share credits may be issued responsive to a purchase of a less expensive content item. In another example, more share credits may be issued for newer content items and less share credits may be issued for older content items.

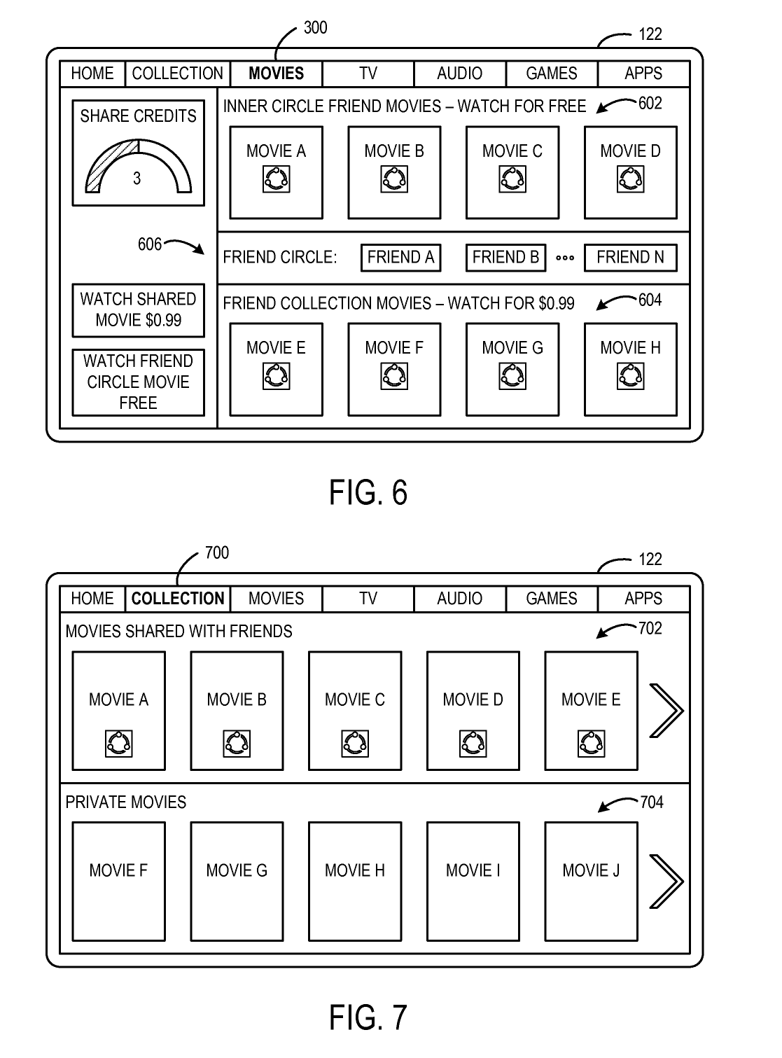

FIG. 6 shows the GUI 122 displaying an example scenario in which a consumer has an inner circle of friends that can barrow movies permanently owned by the consumer without an associated cost. In particular, the movie section 300 may be split into an inner circle friend section 602 and a friend section 604. Movies displayed in the inner circle friend section 602 may be permanently owned by social network friends of the consumer that have selected the consumer as an inner circle friend. The movies displayed in the inner circle friend section 602 may be consumed by the consumer on a temporary basis without paying an associated cost (e.g., money and/or share credit).Movies displayed in the friend section 604 may be permanently owned and made available to be shared by any social network friends of the consumer. The movies displayed in the friend section 604 may be consumed by the consumer on a temporary basis in exchange for a share credit.

The movie section 300 includes inner circle friends 606 of the consumer. The inner circle friends of the consumer may be a limited subset of social network friends that is less than all social network friends of the consumer. The inner circle friends of the consumer may be allowed to consume on a temporary basis some to all content items permanently owned and made available by the consumer without paying an associated cost.

FIG. 7 shows the GUI 122 displaying an example scenario in which a consumer designates permanently owned movies as shared movies or private movies. In particular, the GUI displays a consumer collection section 700 that includes the consumer's permanently owned movies. The collection section includes a shared movies section 702 and a private movies section 704. Movies in the shared movies section 702 may be allowed to be available to be consumed on a temporary basis by social network friends of the consumer in exchange for a share credit. Ownership by the consumer of movies in the private movie section 704 may be hidden from social network friends of the consumer. For example, private movies may be omitted from view in particular sections of the content catalogue. In another example, private movies may be shown without a share icon.

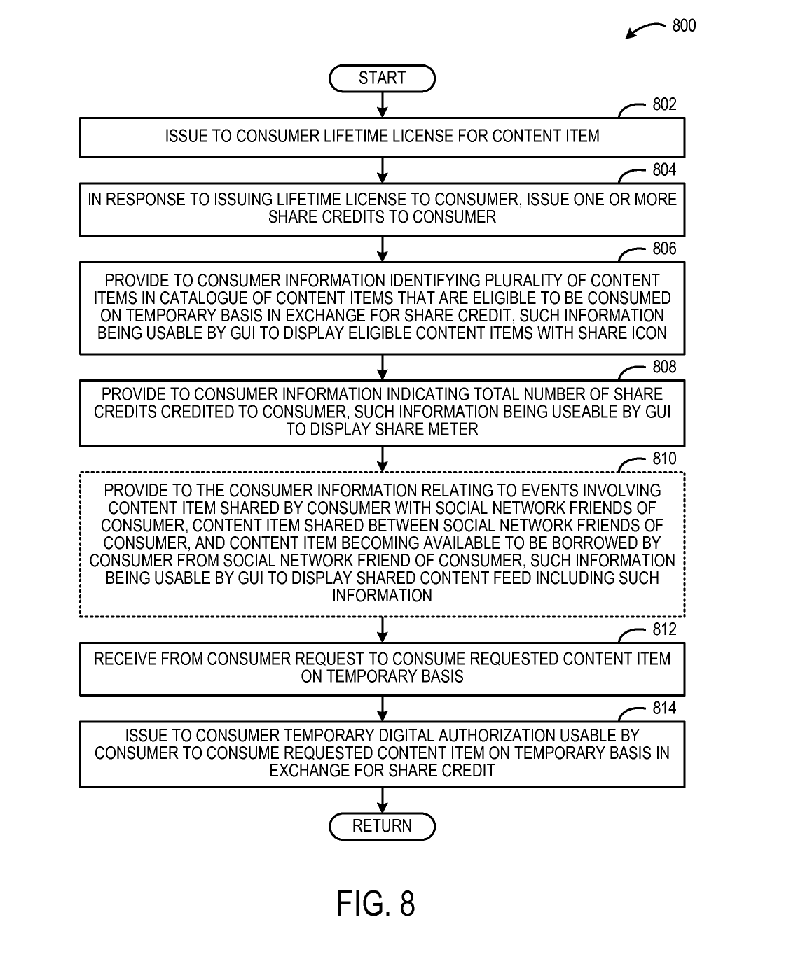

FIG. 8 shows a method 800 for managing consumption of content according to an embodiment of the present disclosure. In one example, the method 800 may be performed by the content management service computer 104 shown in FIG. 1. In another example, the method 800 may be performed by the computing system 1200 shown in FIG. 12.

At 802, the method 800 may include issuing to a consumer a lifetime license for a content item. In one example, the consumer may be issued the lifetime license for the content item responsive to the consumer paying a purchase fee.

At 804, the method 800 may include, in response to issuing the lifetime license to the consumer, issuing one or more share credits to the consumer.

At 806, the method 800 may include providing to the consumer information identifying a plurality of content items in a catalogue of content items that are eligible to be consumed on a temporary basis in exchange for a share credit. Such information may be usable by a GUI to display each eligible content item with a share icon.

At 808, the method 800 may include providing to the consumer information indicating a total number of share credits credited to the consumer. Such information may be usable by the GUI to display a share meter indicating the total number of share credits of the consumer. The share meter may indicate when a share credit is credited to the consumer, and when a share credit is debited from the consumer.

At 810, the method 800 may optionally include providing to the consumer information relating to events involving a content item shared by the consumer with social network friends of the consumer, a content item shared between social network friends of the consumer, and a content item becoming available to be borrowed by the consumer from a social network friend of the consumer. Such information may be usable by the GUI to display a shared content feed including such information.

At 812, the method 800 may include receiving from the consumer a request to consume a requested content item on a temporary basis. For example, the consumer may select the requested content item from the catalogue.

At 814, the method 800 may include issuing to the consumer a temporary digital authorization usable by the consumer to consume the requested content item on a temporary basis in exchange for a share credit.

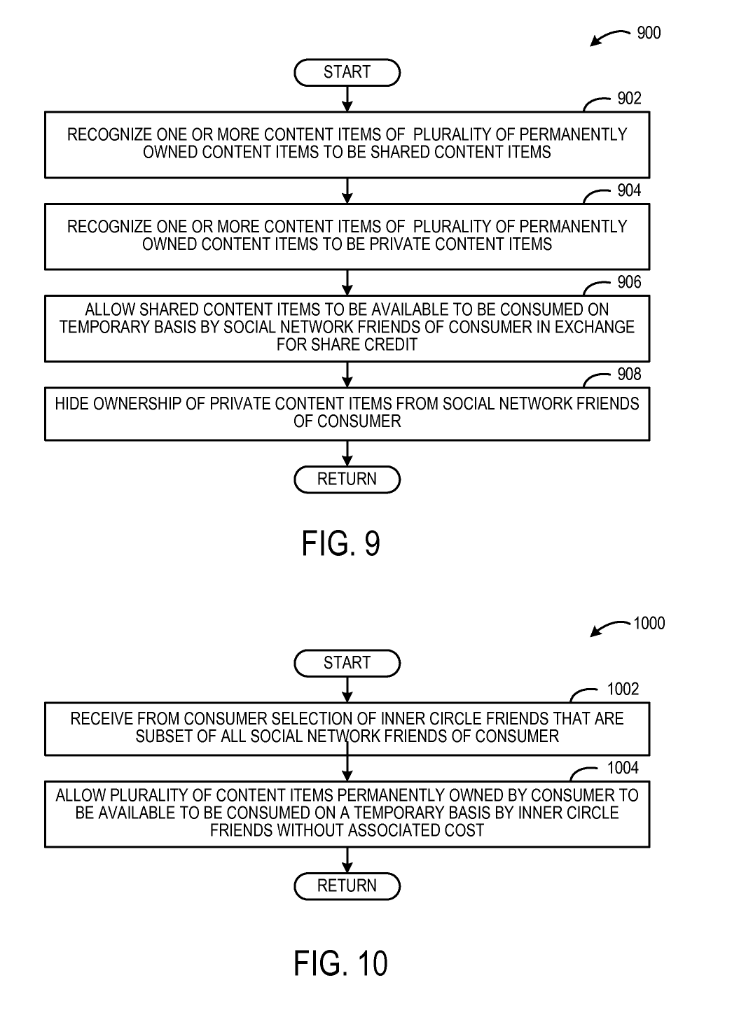

FIG. 9 shows a method for managing privacy of content permanently owned by a consumer according to an embodiment of the present disclosure. In one example, the method 900 may be performed by the content management service computer 104 shown in FIG. 1. In another example, the method 900 may be performed by the computing system 1200 shown in FIG. 12.

At 902, the method 900 may include recognizing one or more content items of a plurality of permanently owned content items to be shared content items.

At 904, the method 900 may include recognizing one or more content items of the plurality of content items permanently owned by the consumer to be private content items.

At 906, the method 900 may include allowing the shared content items to be available to be consumed on a temporary basis by social network friends of the consumer in exchange for a share credit. In one example, the shared content items may be displayed in a GUI with a share icon.

At 908, the method 900 may include hiding ownership by the consumer of the private content items from the social network friends of the consumer. In one example, a GUI may display content items shared by friends that are available to be consumed in exchange for a share credit, and the private content items may be omitted from display in the GUI. In another example, a GUI may display a plurality of content items. Some of the plurality of content items may be displayed with a share icon, and the private content items may be displayed without a share icon.

FIG. 10 shows a method 1000 for managing content sharing for an inner circle of friends of a consumer according to an embodiment of the present disclosure. In one example, the method 1000 may be performed by the content management service computer 104 shown in FIG. 1. In another example, the method 1000 may be performed by the computing system 1200 shown in FIG. 12.

At 1002, the method 1000 may include receiving from the consumer a selection of inner circle friends that are a limited subset of all social network friends of the consumer.

At 1004, the method 1000 may include allowing the plurality of content items permanently owned by the consumer to be available to be consumed on a temporary basis by the inner circle friends without an associated cost. For example, the inner circle friends may consume a content item of the consumer on a temporary basis without having to exchange a share credit or pay a share fee.

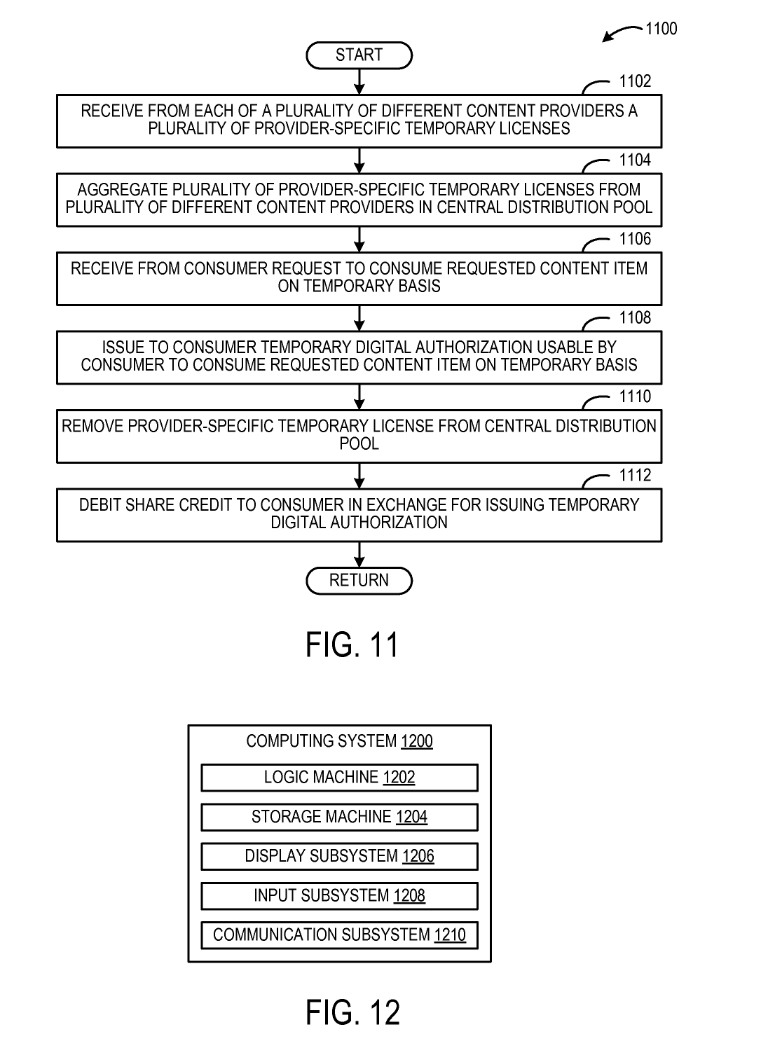

FIG. 11 shows a method for managing distribution of content licenses of a plurality of content providers according to an embodiment of the present disclosure. In one example, the method 800 may be performed by the content management service computer 104 shown in FIG. 1. In another example, the method 800 may be performed by the computing system 1200 shown in FIG. 12.

At 1102, the method 1100 may include receiving from each of a plurality of different content providers a plurality of provider-specific temporary licenses.

At 1104, the method 1100 may include aggregating the plurality of provider-specific temporary licenses from the plurality of different content providers in a central distribution pool.

At 1106, the method may include receiving from a consumer a request to consume a requested content item on a temporary basis.

At 1108, the method 1100 may include issuing to the consumer a temporary digital authorization usable by the consumer to consume the requested content item on a temporary basis.

At 1110, the method 1100 may include in response to issuing the temporary digital authorization, removing a provider-specific temporary license from the central distribution pool. The provider-specific temporary license may be from a content provider of the requested content item.

At 1112, the method 1100 may include debiting a share credit from the consumer in exchange for issuing the temporary digital authorization.

It will be understood that some of the method steps described above may in some embodiments be omitted without departing from the scope of this disclosure. Likewise, the indicated sequence of the method steps may not always be required to achieve the intended results, but is provided for ease of illustration and description. One or more of the method steps may be performed repeatedly, depending on the particular strategy being used. In some embodiments, one or more of the above described methods may be performed in combination.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 12 schematically shows a non-limiting embodiment of a computing system 1200 that can enact one or more of the methods and processes described above. Computing system 1200 is shown in simplified form. Computing system 1200 may take the form of one or more personal computers, server computers, tablet computers, home-entertainment computers, network computing devices, gaming devices, mobile computing devices, mobile communication devices (e.g., smart phone), and/or other computing devices. For example, the computing system 1200 may be representative of any of the computers in the computing system 100 shown in FIG. 1

Computing system 1200 includes a logic machine 1202 and a storage machine 1204. Computing system 1200 may optionally include a display subsystem 1206, input subsystem 1208, communication subsystem 1210, and/or other components not shown in FIG. 12.

Logic machine 1202 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1204 includes one or more physical devices configured to hold instructions executable by the logic machine to implement the methods and processes described herein. When such methods and processes are implemented, the state of storage machine 1204 may be transformed—e.g., to hold different data.

Storage machine 1204 may include removable and/or built-in devices. Storage machine 1204 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1204 may include volatile, nonvolatile, dynamic, static, read/write, read-only, random-access, sequential-access, location-addressable, file-addressable, and/or content-addressable devices.

It will be appreciated that storage machine 1204 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1202 and storage machine 1204 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

It will be appreciated that a “service”, as used herein, is an application program executable across multiple user sessions. A service may be available to one or more system components, programs, and/or other services. In some implementations, a service may run on one or more server-computing devices.

When included, display subsystem 1206 may be used to present a visual representation of data held by storage machine 1204. This visual representation may take the form of a GUI. As the herein described methods and processes change the data held by the storage machine, and thus transform the state of the storage machine, the state of display subsystem 1206 may likewise be transformed to visually represent changes in the underlying data. Display subsystem 1206 may include one or more display devices utilizing virtually any type of technology. Such display devices may be combined with logic machine 1202 and/or storage machine 1204 in a shared enclosure, or such display devices may be peripheral display devices.

When included, input subsystem 1208 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1210 may be configured to communicatively couple computing system 1200 with one or more other computing devices. Communication subsystem 1210 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1200 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device, a method for managing consumption of content, comprising:
issuing to a consumer a lifetime license for a content item;
in response to issuing the lifetime license to the consumer, issuing one or more share credits to the consumer;
receiving from the consumer a request to consume a requested content item on a temporary basis; and
issuing to the consumer a temporary digital authorization usable by the consumer to consume the requested content item on a temporary basis in exchange for a share credit.

2. The method of claim 1, wherein the one or more share credits can only be exchanged for a temporary digital authorization usable by the consumer to consume content items that are permanently owned via a lifetime license by any social network friend of the consumer.

3. The method of claim 2, further comprising:
providing to the consumer information identifying a plurality of content items in a catalogue of content items that are eligible to be consumed on a temporary basis in exchange for a share credit, such information being usable by a graphical user interface to display each eligible content item with a share icon.

4. The method of claim 1, further comprising:
providing to the consumer information indicating a total number of share credits credited to the consumer, such information being usable by a graphical user interface to display a share meter indicating the total number of share credits, the share meter indicating when a share credit is credited to the consumer, and the share meter indicating when a share credit is debited from the consumer.

5. The method of claim 1, further comprising:
providing to the consumer information relating to events involving a content item being shared by the consumer with social network friends of the consumer, a content item being shared between social network friends of the consumer, and a content item becoming available to be borrowed by the consumer from a social network friend of the consumer, such information being usable by a graphical user interface to display a shared content feed including such information.

6. The method of claim 3, wherein one or more content items of the catalogue are available for consumption on a permanent basis in exchange for a first cost, wherein the one or more content items in the catalogue are available for consumption on a temporary basis in exchange for a second cost that is less than the first cost, and wherein the one or more content items in the catalogue are available for consumption on a temporary basis in exchange for a share credit and a third cost that is less than the second cost.

7. The method of claim 1, wherein the content item is one of a plurality of content items permanently owned by the consumer via lifetime licenses, and the method further comprises:
recognizing one or more content items of the plurality of content items to be shared content items;
recognizing one or more content items of the plurality of content items to be private content items;
allowing the shared content items to be available to be consumed on a temporary basis by social network friends of the consumer in exchange for a share credit; and
hiding ownership of the private content item from the social network friends of the consumer.

8. The method of claim 1, wherein the content item is one of a plurality of content items permanently owned by the consumer via lifetime licenses, and the method further comprises:
receiving from the consumer a selection of inner circle friends that are a limited subset of all social network friends of the consumer;
allowing the plurality of content items permanently owned by the consumer to be available to be consumed on a temporary basis by the inner circle friends without an associated cost.

9. The method of claim 1, wherein a temporary digital authorization for a social network friend of the consumer to consume a content item permanently owned by the consumer is exchanged for one or more share credits.

10. A storage machine holding instructions executable by a logic machine to:
issue to a consumer a lifetime license for a content item;
in response to issuing the lifetime license to the consumer, issue one or more share credits to the consumer;
receive from the consumer a request to consume a requested content item on a temporary basis; and
issue to the consumer a temporary digital authorization usable by the consumer to consume the requested content item on a temporary basis in exchange for a share credit.

11. The storage machine of claim 10, wherein the one or more share credits can only be exchanged for a temporary digital authorization usable by the consumer to consume content items that are permanently owned via a lifetime license by any social network friend of the consumer.

12. The storage machine of claim 10, further holding instructions executable by the logic machine to:
provide to the consumer information identifying a plurality of content items in a catalogue of content items that are eligible to be consumed on a temporary basis in exchange for a share credit, such information being usable by a graphical user interface to display each eligible content item with a share icon.

13. The storage machine of claim 10, further holding instructions executable by the logic machine to:
provide to the consumer information indicating a total number of share credits credited to the consumer, such information being usable by a graphical user interface to display a share meter indicating the total number of share credits, the share meter indicating when a share credit is credited to the consumer, and the share meter indicating when a share credit is debited from the consumer.

14. The storage machine of claim 12, further holding instructions executable by the logic machine to:
provide to the consumer information relating to events involving a content item being shared by the consumer with social network friends of the consumer, a content item being shared between social network friends of the consumer, and a content item becoming available to be borrowed by the consumer from a social network friend of the consumer, such information being usable by a graphical user interface to display a shared content feed.

15. The storage machine of claim 12, wherein one or more content items of the catalogue are available for consumption on a permanent basis in exchange for a first cost, wherein the one or more content items in the catalogue are available for consumption on a temporary basis in exchange for a second cost that is less than the first cost, and wherein the one or more content items in the catalogue are available for consumption on a temporary basis in exchange for a share credit and a third cost that is less than the second cost.

16. The storage machine of claim 10, wherein the content item is one of a plurality of content items permanently owned by the consumer via lifetime licenses, and the storage machine further holds instructions executable by the logic machine to:
recognize one or more content items of the plurality of content items to be shared content items;
recognize one or more content items of the plurality of content items to be private content items;
allow the shared content items to be available to be consumed on a temporary basis by social network friends of the consumer in exchange for a share credit; and
hiding ownership of the private content items from the social network friends of the consumer.

17. The storage machine of claim 10, wherein the content item is one of a plurality of content items permanently owned by the consumer via lifetime licenses, and the storage machine further holds instructions executable by the logic machine to:
receive from the consumer a selection of inner circle friends that are a limited subset of all social network friends of the consumer;
allow the plurality of content items permanently owned by the consumer to be available to be consumed on a temporary basis by the inner circle friends without an associated cost.

18. The storage machine of claim 10, wherein a number of the one or more share credits issued responsive to issuing the lifetime license for the content item varies based on a type of the content item.

19. A storage machine holding instructions executable by a logic machine to:
receive from each of a plurality of different content providers a plurality of provider-specific temporary licenses;
aggregate the plurality of provider-specific temporary licenses from the plurality of different content providers in a central distribution pool;
receive from a consumer a request to consume a requested content item on a temporary basis;
issue to the consumer a temporary digital authorization usable by the consumer to consume the requested content item on a temporary basis; and
in response to issuing the temporary digital authorization, remove a provider-specific temporary license from the central distribution pool, the provider-specific temporary license being from a content provider of the requested content item.

20. The storage machine of claim 19, further holding instructions executable by the logic machine to:
debit a share credit to the consumer in exchange for issuing the temporary digital authorization.
